(19) United States
(12) Patent Application Publication
(10) Pub. No.: US 2022/0398487 A1
(43) Pub. Date: Dec. 15, 2022

(54) METHODS AND SYSTEMS FOR MOBILITY SOLUTION RECOMMENDATIONS USING GEOSPATIAL CLUSTERING

(71) Applicant: Toyota Motor Engineering & Manufacturing North America, Inc., PLANO, TX (US)

(72) Inventors: Dario J. Villarreal, Farmers Branch, TX (US); Bryan Schulz, Prosper, TX (US); David Fish, Bentonville, AR (US)

(73) Assignee: Toyota Motor Engineering & Manufacturing North America, Inc., PLANO, TX (US)

(21) Appl. No.: 17/344,351

(22) Filed: Jun. 10, 2021

(51) Int. Cl. G06N 20/00; G06F 16/29; G06F 16/23; G06F 16/9537

(52) U.S. Cl. CPC G06N 20/00; G06F 16/29; G06F 16/2365; G06F 16/9537

(57) ABSTRACT

In an embodiment, recommending mobility solutions includes receiving a set of geospatial data corresponding to a geographic location, and generating a set of geospatial clusters based on the geographic location and the set of geospatial data, wherein each geospatial cluster of the set of geospatial clusters has a set of mobility solutions and a set of geographic regions. The method also includes receiving a set of profiling data corresponding to a set of users in each geospatial cluster, and generating a set of profile sub-clusters corresponding to each geographic region based on the set of profiling data. The method further includes identifying a set of met needs and a set of unmet needs of the set of users in each profile sub-cluster, and generating a mobility solution recommendation associated with a set of unmet needs of a set of users in a profile sub-cluster of a geospatial cluster.

### TECHNICAL FIELD

The present disclosure relates to mobility solutions and transportation, and more particularly to methods and systems that provided recommendations to users as to what type of mobility solutions should be developed for a target region.

### BACKGROUND

Implementing new mobility solutions can be an incredibly challenging task because of the number of geospatial variables that must be accounted for. For example, the United States of America (USA) is a very geographically diverse country having a broad range of population density as well as a broad range of geographic terrain, and thus a mobility solution that may be effective in one area may not be in another. Additionally, there are many different types of mobility solutions available. Many mobility solutions may be ideal for certain types of environments as well as ideal for certain types of people. For example, buses may be more utilized in dense cities, and thus may be more well-received in dense cities.

To account for the wide range of variables in determining what new mobility solution to implement in a target region, cities or companies must conduct extensive studies of other regions of the country. A variety of other regions, where the mobility solution is already in place, must be studied to determine the efficacy of the mobility solution. If other regions are similar to the target region, the mobility solutions of the other regions are likely to be effective in the target region. If the other regions and the target region have similar personalities within their population, similar mobility solutions are likely to be similarly received. However, such studies are expensive and time-consuming. Therefore, there is a need for a streamlined and automated approach to recommending mobility solutions.

### SUMMARY

In accordance with one embodiment of the present disclosure, a method for recommending mobility solutions includes receiving a set of geospatial data corresponding to a geographic location, and generating, by a machine learning module, a set of geospatial clusters based on the geographic location and the set of geospatial data, wherein each geospatial cluster of the set of geospatial clusters has a set of mobility solutions and a set of geographic regions. The method also includes receiving a set of profiling data corresponding to a set of users in each geospatial cluster, and generating, by the machine learning module, a set of profile sub-clusters corresponding to each geographic region based on the set of profiling data. The method further includes identifying a set of met needs and a set of unmet needs of the set of users in each profile sub-cluster, and generating a mobility solution recommendation associated with a set of unmet needs of a set of users in a profile sub-cluster of a geospatial cluster.

In accordance with another embodiment of the present disclosure, a system for recommending mobility solutions includes a processor, a machine learning module, a memory component communicatively connected to the processor, and machine-readable instructions stored in the memory component. When executed by the processor, the machine-readable instructions cause the processor to receive a set of geospatial data corresponding to a geographic location, and generate, by the machine learning module, a set of geospatial clusters based on the geographic location and the set of geospatial data, wherein each geospatial cluster of the set of geospatial clusters has a set of mobility solutions and a set of geographic regions. The machine-readable instructions also cause the processor to receive a set of profiling data corresponding to a set of users in each geospatial cluster, and generate, by the machine learning module, a set of profile sub-clusters corresponding to each geographic region based on the set of profiling data. The machine-readable instructions further cause the processor to identify a set of met needs and a set of unmet needs of the set of users in each profile sub-cluster, and generate a mobility solution recommendation associated with a set of unmet needs of a set of users in a profile sub-cluster of a geospatial cluster.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts a flowchart of an example method for mobility solution recommendations using geospatial clustering, according to one or more embodiments shown and described herein;

FIG. 2 depicts a flowchart of an example method for geospatial clustering, according to one or more embodiments shown and described herein;

FIG. 3 depicts a list of example categories of relevant geospatial data, according to one or more embodiments shown and described herein;

FIG. 4 depicts a map of an example geographic location having clusters based on geospatial similarities, according to one or more embodiments shown and described herein;

FIG. 5 depicts a flowchart of an example method for profile sub-clustering, according to one or more embodiments shown and described herein;

FIG. 6 depicts a map of an example geospatial cluster with profile sub-clusters based on profiling similarities, according to one or more embodiments shown and described herein;

FIG. 7 depicts a flowchart of an example method for preference modeling, according to one or more embodiments shown and described herein;

FIG. 8 depicts a flowchart of an example method for solution generation, according to one or more embodiments shown and described herein; and

FIG. 9 depicts a schematic diagram depicting an example computing device, according to one or more embodiments shown and described herein.

### DETAILED DESCRIPTION

Geospatial data refers to data relating to the mobility of persons in a particular area. For example, geography, landscape architecture, and population density are all factors that may impact how a person may navigate from one part of a city to another. The geospatial data of a city or region may capture the attributes of a city that can be processed to reveal further attributes about the city. Furthermore, geospatial data may be derived from a variety of publically available databases, such as the geographic information system (GIS) data from the United States Geological Survey (USGS). It should be understood that, as used herein, “city” may refer to towns, villages, parishes, counties, and any other municipal region.

Profiling data refers to data relating to the personality and habits of people in a particular area. For example, age, occupation, and socioeconomic status are all factors that may impact how a person may choose to navigate from one part of a city to another. The profiling data of a group of people in a city may capture the attributes of the group of people that can be processed to reveal further attributes about the group of people. Furthermore, profiling data may comprise two categories: objective profiling data and subjective profiling data. Objective profiling data may be data that is not directly gathered from an individual, such as GPS location data that is collected automatically over a period of time. Subjective profiling data may be data that is directly gathered from an individual, such as survey data that is collected in response to a solicitation for feedback.

Mobility solutions refer to modes of transportation that address a category of mobility. A mode of transportation may refer to any vehicle that may be used to get a person from one location to another. A category of mobility may refer to any scale of mobility. For example, a recently popularized form of mobility solution is shared electric scooters that address the need for micro-mobility in areas where walking and biking are common.

When city planners or companies are making the determination of what new mobility solution to develop, analyzing other geographic regions may provide insight as to what is effective and what is ineffective based on the region's characteristics. Regions having similar features may be a useful cue to provide similar mobility solutions. Furthermore, regions with individuals who have similar preferences or mobility habits while utilizing their region's mobility solutions may also be a useful cue in recommending new and appropriate mobility solutions.

The methods and systems disclosed herein enable a comprehensive analysis of an entire geographic location in an automated fashion. Embodiments may utilize geospatial clustering to cluster regions of a geographic location based on geospatial data to identify regions of the geographic location that are similar to each other such that mobility solutions that are effective in one region of a geospatial cluster are likely to be effective in another region of the geospatial cluster. Embodiments may also cluster geospatial clusters based on profiling data to identify sub-clusters of each region to consider the similarity of regions on an individual level as well as a geospatial level. This helps ensure that what may be effective in the region may also be desired and/or utilized in the region.

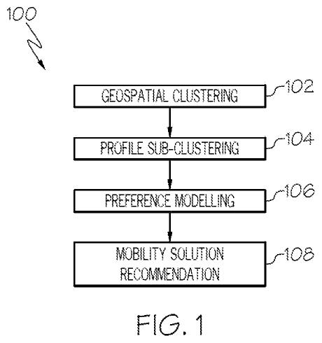

Referring now to FIG. 1, a flowchart illustrating a process 100 for mobility solution recommendations based on geospatial clustering is depicted. It should be understood that embodiments are not limited by the order of the steps shown in FIG. 1 nor are embodiments limited to the steps included in FIG. 1.

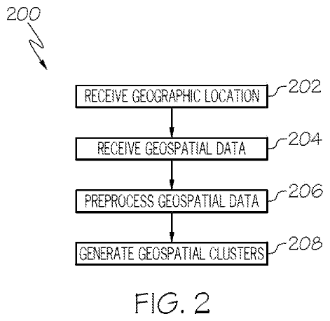

The process begins with geospatial clustering at block 102. Geospatial clustering is the process of segmenting a geographic location into a series of clusters, as discussed in more detail in the discussion of FIGS. 2-4, below. Geospatial clusters represent regions of the geographic location that are similar to each other, where similarity is a function of geospatial data. For example, two cities (i.e., regions) that are on opposite sides of the country (i.e., a geographic location) may be grouped into the same cluster because they are geospatially similar although they are geographically far apart. When each part of the geographic location is placed into a geospatial cluster, the process moves to block 104.

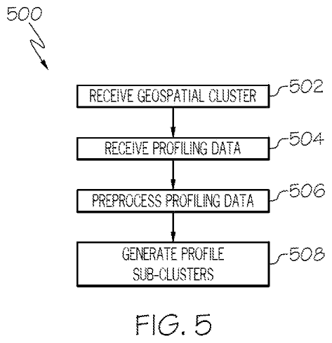

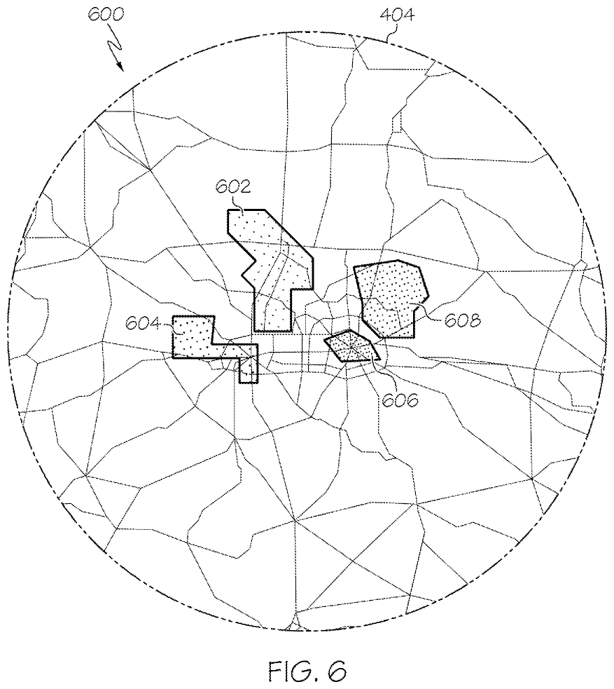

At block 104, geospatial clusters may be further segmented by a process of profile sub-clustering. Profile sub-clustering is the process of segmenting each geographic region of a geospatial cluster into a series of clusters, as discussed in more detail in the discussion of FIGS. 5-6, below. Profile sub-clusters represent portions of a region where people exhibiting similar characteristics may live. For example, a first city may have a neighborhood where most people take public transportation to commute to work and another neighborhood where most people drive to work, and a second city hundreds of miles away may also have a neighborhood where most people take public transportation to commute to work but is dense enough such that there is no neighborhood where most people drive to work. In this example, if both cities are in the same geospatial cluster, both cities will have one shared profile sub-cluster. Identifying the shared profile sub-cluster in the same geospatial cluster will allow the system to first reference the first city's mobility solutions when determining what mobility solutions to recommend that are likely to be effective in the shared profile sub-cluster of the second city.

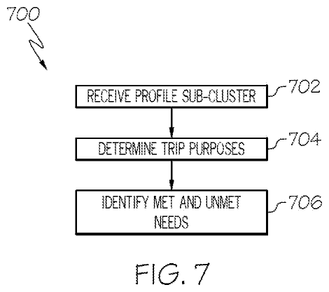

At block 106, the users of a profile sub-cluster may be analyzed via preference modeling. Preference modeling is the process of identifying the met and unmet needs of the users regarding their travel habits, as discussed in more detail in the discussion of FIG. 7, below. Whereas geospatial clustering may use objective data and profile sub-clustering may use a combination of objective and subjective data, preference modeling may use subjective data. For example, preference modeling may gather survey data from users in each profile sub-cluster to identify the trips they typically take and their travel preferences to determine which of their preferences are and are not met for their trips. These preferences may be referred to as “needs” that the user has with respect to mobility.

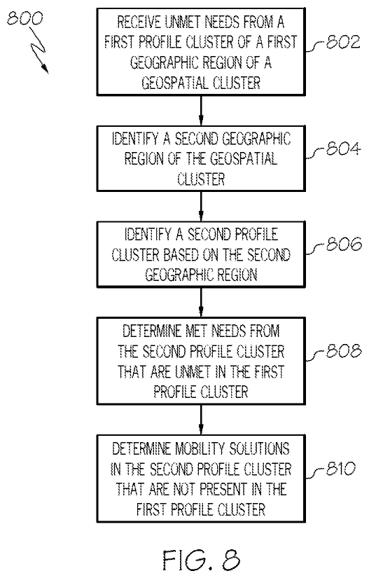

At block 108, mobility solutions may be recommended, as discussed in more detail in the discussion of FIG. 8, below. Recommending mobility solutions that can meet the unmet needs of the users identified in block 106 of the process 100 may begin by looking to another region of the same cluster because mobility solutions that are effective in one region of a cluster are likely to also be effective in another region of the same cluster because of their geospatial similarity. However, just because two regions are geospatially similar does not necessarily mean that a new mobility solution may be met with the same level of acceptance by their potential users. To account for differences among user personalities, the system may focus on a common profile sub-cluster between the two regions and recommend mobility solutions that are effective and well-received in the common profile sub-cluster because commonality in profile sub-cluster may indicate commonality in personality and thus similar levels of acceptance. The recommended solutions that are most likely to be met with acceptance are those that are implemented in profile sub-clusters in the same geospatial cluster where met needs may be attributed to the mobility solution. If a mobility solution can meet an unmet need in a profile sub-cluster in one region of a geospatial cluster, it will also likely meet an unmet need in a profile sub-cluster in another region of a geospatial cluster. Even if there are many unmet needs as well as many potential mobility solutions to potentially meet the unmet needs such that it is difficult to determine which mobility solutions will meet which unmet need, the field of potential mobility solutions has been narrowed by leveraging the commonality in geospatial features and user personality without having to perform detailed transportation studies throughout the entirety of the geographic location.

Referring now to FIG. 2, a flowchart illustrating a process 200 for geospatial clustering is depicted. The goal of geospatial clustering is to generate geospatial clusters that group similar geographic regions to potentially draw inferences between similar geographic regions. It should be understood that embodiments are not limited by the order of the steps shown in FIG. 2 nor are embodiments limited to the steps included in FIG. 2.

The process 200 begins at block 202 where a geographic location may be received. A geographic location represents a broader area that may be broken down into smaller areas for comparing the smaller areas. For example, a geographic location may be a country that may be broken down into counties for comparing counties to one another. It should be understood that a geographic location does not have to be strictly delimited by geopolitical boundaries. However, geopolitical boundaries may simplify the system when it comes to data collection further along in the process. Further discussion about process 200 may use the USA as an example geographic location.

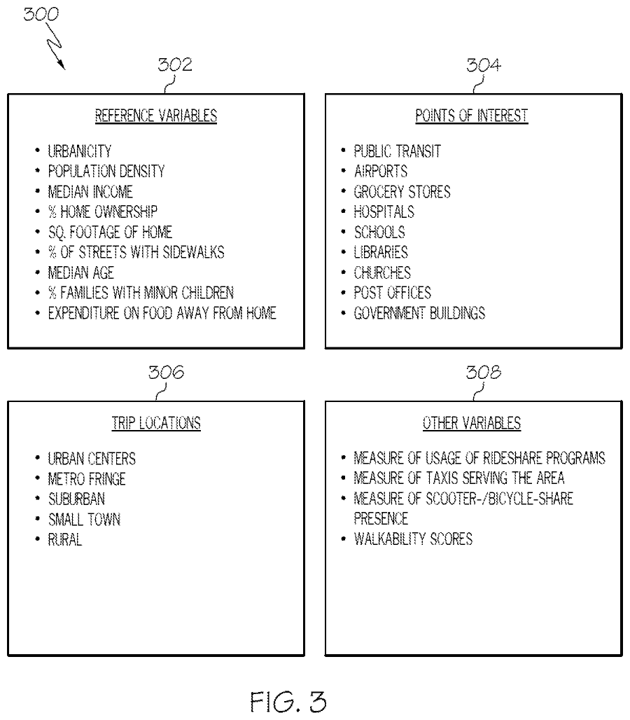

At block 204, geospatial data may be received. To reiterate, geospatial data refers to data relating to the mobility of persons in a particular area. For example, geography, landscape architecture, and population density are all factors that may impact how a person may navigate from one part of a city to another. Particular categories of geospatial data are outlined in the discussion of FIG. 3, below. Geospatial data may be derived from a variety of publically available databases, such as the geographic information system (GIS) data from the United States Geological Survey (USGS) agency. Geospatial data may also be derived from proprietary databases. However, geospatial data from publicly available sources may be ideal because they may contain information that is difficult for private persons to obtain and they may be routinely updated.

At block 206, the geospatial data may be preprocessed. Preprocessing may make the clustering analysis more accurate by removing noise such as biasing data points, inconsistencies, and/or outliers. Additionally, preprocessing the geospatial data may increase the efficiency of the clustering process by reducing the size of the data set or modifying the data set to make the data more statistically meaningful. Preprocessing may include, for example, fitting the data into numeric values, normalizing the data, and/or transforming the data. Fitting the data to a numeric value allows the data to be processed by a computer. However, raw numeric values may too similar to generate meaningful clusters. One solution may be to normalize the data by calculating the z-score for each data point, which is a numerical measurement that describes a data point's relationship to the mean of a data set. Another solution may be to transform the data. For instance, if the data is distributed such that the data is substantially grouped on one end of a scale, such as in a power law graph, a log transform may create a less compacted distribution. However, preprocessing is not limited to the examples provided.

At block 208, geospatial clusters may be generated. Geospatial clusters may be generated by clustering the geographic location into a set of clusters wherein each cluster contains geographic regions that contain similar geospatial data. A geographic location may be a broader area, such as a country, whereas a geographic region is a sub-area of the geographic location, such as a city. For example, the system may receive the USA as a geographic location and the USA may be clustered by city. Clustering may be performed by a machine learning module utilizing a clustering algorithm to generate a plurality of clusters. In some embodiments, the clustering algorithm may include a hierarchical cluster analysis, a centroid-based cluster analysis (e.g., K-means or a variant thereof), a graph-based cluster analysis (e.g., a graph community detection algorithm).

The goal of the clustering algorithm is to generate clusters that are groupings of geographic regions with geospatial similarities. For example, assume a geographic location has geographic regions A, B, C, and D. If geographic regions A and C are in a first cluster and geographic regions B and D are in a second cluster, then A is more similar to C than to either B or D, B is more similar to D than to either A or C, and so on.

To illustrate, in a K means clustering algorithm, for example, the algorithm comprises an initialization step, an assigning step, and an updating step. In the initialization step, K cities may be selected from the plurality of cities as centroids of K clusters. K is at least 2 and no greater than the total number of data points, but in some embodiments K may be a predetermined number or adaptively determined based on the number of features (i.e., categories) of the geospatial data. The centroid placement is typically random but may be placed according to a predetermined manner to optimize results. The geospatial data is in a form that may be plotted onto a multidimensional graph, where each dimension of the graph may be represented by a feature of the geospatial data. FIG. 3 illustrates example categories of geospatial data that may be represented as features in a multidimensional graph. After initialization, the K means algorithm engages in an iterative process between an assigning step and an updating step.

Following the initialization step, the K means algorithm may proceed to an assigning step. In the assigning step, the K means algorithm traverses through each data point. At each data point, the data point is assigned to a cluster based on which cluster centroid the data point is located closest to. For example, the Euclidian distance between a data point and each centroid is calculated, the data point is assigned to the closest centroid to be a part of that centroid's cluster, and the process is repeated for the remaining data points.

Following the assigning step, the K means algorithm may proceed to an updating step. The updating step updates the location of the centroid to better represent the central location of the new cluster generated by the assigning step. The algorithm calculates the average location of each data point of a cluster and moves the cluster centroid to the calculated position. The algorithm performs this calculation for each cluster.

Following the updating step, the assigning step and the updating step are repeated until a predetermined number of iterations or the centroid does not move beyond a threshold amount in the updating step. In other words, the assigning step and the updating step are repeated until the centroids have converged. Once the assigning step and the updating step are complete, the clustering analysis is complete.

Referring now to FIG. 3, a list 300 of relevant geospatial data categories is depicted. Geospatial data is any data that can impact the mobility of persons within a geographic area. Each category of data in the list 300 may represent one or more features that can be quantified and plotted on a graph for use by a clustering algorithm, where each feature may represent a dimension on a graph. Weights may be applied to the data to emphasize the importance of particular categories of data over other categories of data.

Key categories of geospatial data may include data for predetermined reference variables 302, points of interest 304, trip locations 306, as well as other variables 308. Data in reference variables 302 may include data such as urbanicity, population density, median income, median age, home ownership rate, home size, sidewalk coverage, number of families, number of families with children, family expenditures on food, and other population characteristics. Reference variable 302 data may be collected from publicly available databases at the broader level of the geographic location, such as the US Census, or lower levels of the geographic location, such as County Profiles from state level entities like the Ohio Office of Research. Data in points of interest 304 may include public transit, airports, grocery stores, hospitals, schools, libraries, churches, and other points of interest. Points of interest 304 data may be collected from publicly available databases, such as the US Geological Survey, and open source or proprietary databases, such as Google Maps and other cartography services. Data in trip locations 306 may include trips to/from urban centers, metro fringes, suburban areas, small towns, rural areas, and other trip locations. Trip location 306 data may be collected from open source or proprietary databases, such as Google Maps and other cartography services. Other variables 308 may include measures of usage of rideshare programs, measures of taxis serving the area, measures of scooter-/bicycle-share presence, walkability scores, and other mobility metrics. Data for other variables 308 may be collected from open source or proprietary databases, such as Uber and other mobility services. For example, scooter-share companies may share datasets about the location and availability of their scooters in certain locations in the form of application programming interfaces (APIs) for software developers to include in their programs.

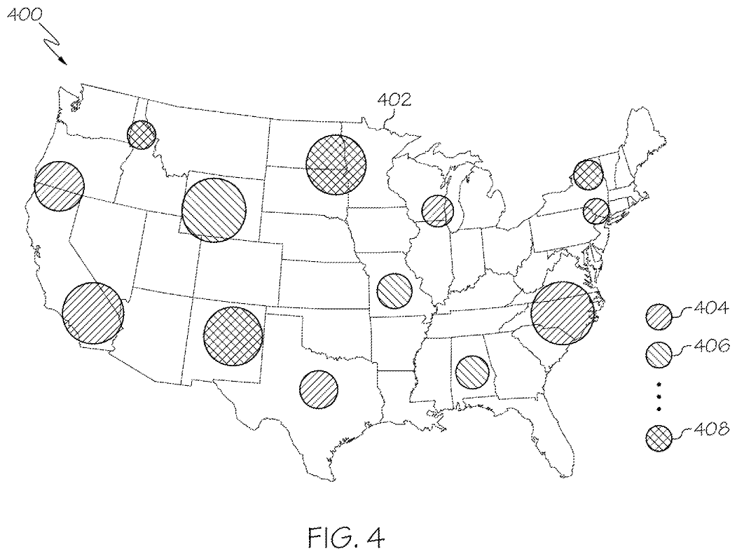

Referring now to FIG. 4, a cluster map 400 of a geographic location 402 with geospatial clusters 404-408 is shown. The map 400 may be generated in block 208 of the geospatial clustering process 200. The geographic location 402 may be one or more countries. However, it should be understood that the selection of a geographic location 402 is not limited to any particular geopolitical boundaries and may be selected based on other standards to generate better recommendations. For example, if it is desired to find mobility solution recommendations for Guatemala City, Guatemala, the geographic location selected may also include Mexico and the USA because they are much larger and contain more robust transportation networks that can provide more data to supplement data from Guatemala. Instead of Mexico and the USA, the geographic location may be locations within a 1500 mile radius, for example, to utilize data from regions that are more localized and thus likely to be more relevant.

The geospatial clusters 404-408 contain geographic regions of geographic location 402, such as counties and cities, that are grouped by their similarity in terms of their geospatial data. In other words, geospatial clusters 404-408 are groups of geographic locations that share similar geospatial features. For instance, if the geographic location 402 is the USA, Chicago and New York may be in the same cluster 404 because they share similar geospatial data, (e.g., they are both densely populated, urban areas with relatively flat terrain, wherein most traveling is done for work). Some embodiments may generate a visual output of the resulting clusters in the form of a map 400 image overlaid with geospatial clusters 404-408. The clusters may be each geographic region color-coded according to the cluster to which they belong. For example, if the geographic regions are USA counties, then each county may be colored to fill in the entire map 400 of the USA to help visualize the geospatial clusters. Some embodiments may generate a similar, non-visual output for use in a virtual environment, such as a relational database having a table where each geographic region is a tuple that contains data for each attribute as listed in FIG. 3 and a pointer that relates the tuple to its geospatial cluster as represented by another table having pointers to other geographic regions in that cluster.

Referring now to FIG. 5, a flowchart illustrating a process 500 for profile sub-clustering is depicted. The goal of profile sub-clustering is to generate profile sub-clusters that capture the personality of the individuals who live in the localized regions of a geographic region. It should be understood that embodiments are not limited by the order of the steps shown in FIG. 5 nor are embodiments limited to the steps included in FIG. 5.

The profile sub-clustering process 500 begins at block 502 where geospatial clusters generated from the geospatial clustering process 200 are received. The process 500 should have at least one geospatial cluster generated from process 200. A single cluster is sufficient because geographic regions included in a geospatial cluster are similar to each other due to the nature of the clustering algorithm. Comparing a geographic region from one geospatial cluster to a geographic region from another geospatial cluster would not be ideal because the two regions are dissimilar and thus mobility solutions that may work in one geographic region may not be effective in the other. However, comparing a geographic region from one geospatial cluster to a geographic region in the same geospatial cluster would be ideal because mobility solutions that may work in one geographic region are likely to work in the other due to similarities between the geographic regions and their geospatial data.

At block 504, profiling data may be received. To reiterate, profiling data refers to data relating to the personality and habits of people in a particular area. For example, age, occupation, marital status, and socioeconomic status are all factors that may impact how a person may choose to navigate from one part of a city to another. Profiling data may comprise two categories: objective profiling data and subjective profiling data. Objective profiling data may be data that is not directly gathered from an individual, such as GPS location data that is collected automatically over a period of time. Subjective profiling data may be data that is directly gathered from an individual, such as survey data that is collected in response to a solicitation for feedback.

At block 506, the profiling data may be preprocessed. Preprocessing may make the clustering analysis more accurate by removing biasing data points and/or outliers and may increase the efficiency of the clustering process. Preprocessing may be performed in a manner similar to the preprocessing in block 206 of process 200.

At block 508, the profile sub-clusters may be generated. Sub-clustering refers to the process of generating clusters within a cluster. Here, sub-clusters may be generated based on profiling data, where the sub-clusters are based on geographic regions that are all located within the same geospatial cluster. Sub-clusters may be representative of a general personality of people living within the sub-cluster and may be determined by their profiling data. For example, a “cut the keys” personality may be reflected by profiling data that indicates that a person is single, between 20-30 years of age, a student, lower to middle income, and in an urban area and thus is more likely to prefer using public transportation over owning a personal automobile. If a neighborhood tends to be occupied by individuals with a “cut the keys” personality, the neighborhood may be grouped into a sub-cluster. It should be understood that sub-clusters can represent any number of personalities that may be defined before or after geospatial clustering. It should also be understood that an area can contain multiple sub-clusters of the same personality type. For example, there may be multiple “cut the keys” neighborhoods in a particular city. Segmenting populations into sub-clusters may be performed by any method, including clustering in a manner similar to the process performed in block 208.

Referring now to FIG. 6, a map 600 of a geospatial cluster 404 with profile sub-clusters 602-608 is shown. The geospatial cluster 404 may include areas smaller than the geographic regions used in the geospatial clustering process 200. For example, if the geographic regions used in the geospatial clustering process 200 were states, then counties, conurbations, cities, and the like may be used for profile sub-clustering, such as the Dallas-Fort Worth metroplex as shown in FIG. 6. As another example, if the geographic regions used in the geospatial clustering process 200 were counties, then conurbations, cities, neighborhoods, and the like may be used for profile sub-clustering.

The sub-clusters 602-608 contain areas within a geographic region of a geospatial cluster 404, such as neighborhoods, that are grouped by their similarity in terms of their profiling data. In other words, sub-clusters 602-208 are groups of areas that have residents with similar personality characteristics. For instance, if the Dallas-Fort Worth metroplex is the geographic region downtown Dallas may be in the same profile sub-cluster as downtown Fort Worth because their residents may have similar profiling data (e.g., personalities). Some embodiments of the profile sub-clustering process 500 may generate a visual output of the resulting clusters in the form of a map 600 overlaid with sub-clusters 602-608. The sub-clusters may be each area (e.g., city, neighborhood, etc.) color-coded according to the sub-cluster to which they belong. Some embodiments may generate a similar, non-visual output for use in a virtual environment.

Referring now to FIG. 7, a flowchart of a process 700 for preference modeling is depicted. The goal of preference modeling is to identify the met and unmet needs of the individuals who live in the sub-clusters. It should be understood that embodiments are not limited by the order of the steps shown in FIG. 7 nor are embodiments limited to the steps included in FIG. 7.

The preference modeling process 700 begins at block 702 where profile sub-clusters generated from the profile sub-clustering process 500 are received. To recall, the data associated with the profile sub-cluster is the profiling data of the individuals that live within the sub-clusters. The data of the individuals that live within each sub-cluster may be used to carry out block 704 and block 706 to model the preferences of the individuals and determine which of those preferences are met or unmet. Unmet preferences, i.e., unmet needs, represent a “pain point” in the transportation process for individuals in an area. Identifying how many people are facing a particular unmet need may be an indicator that a particular mobility solution may be an effective means of meeting the unmet need, thereby improving the quality of mobility for individuals in the sub-cluster.

At block 704, trip purposes of the individuals within a sub-cluster may be determined. Like profiling data, trip purpose data may be determined objectively and subjectively. Trip purposes may be determined objectively by gathering data that is not directly provided by an individual. The system may determine trip destinations through the objective data that may then be associated with a trip purpose. For example, by monitoring GPS data and/or traffic data, if a user goes to an office building, it may be reasonably inferred that the purpose of the trip to the office building is for work. Trip purposes may be determined subjectively by gathering data that is provided directly from an individual. This method may be more accurate, assuming that individuals are forthcoming about the purpose of their trips. For example, in a navigation application on an individual's phone, the individual may receive a prompt asking about the purpose of the individual's trip, to which the individual may select an appropriate response. Trip purposes may include shopping, services, work, social, recreation, spiritual, and other categories of travel.

At block 706, met and unmet needs of individuals may be identified. Needs may be representative of preferences that individuals have concerning their transportation. Accordingly, unmet needs are problems that may not be addressed by current mobility solutions in the area, and thus may be an opportunity for newer mobility solutions. To determine met and unmet needs, individuals may be surveyed to determine their transportation priorities and/or mobility habits. Transportation priorities may include cost, convenience, speed, availability, distance, and other transportation metrics. For example, personal car ownership may be high in speed, distance, and availability but is also high in cost, and thus may not satisfy an individual's transportation priorities for affordable short commutes. By contrast, bike-sharing may be low in speed and distance, but is also low in cost and high in availability and convenience, and thus may satisfy an individual's transportation priorities for affordable short commutes. Mobility habits may include vehicle ownership, commute time, forms of transportation used, how often different forms of transportation are used, and other personal mobility routines. For example, a “traditionalist” may own a car outright and tend to use that car for nearly all forms of mobility. On the other hand, a “tech enthusiast” may own a variety of micro-mobility vehicles (e.g., electric scooters, e-bikes, and the like), despite also owning a car, to experience new, more cutting-edge experiences in mobility technology.

A need may be met when an identified transportation priority aligns with a current mobility habit. Conversely, a need may be unmet when an identified transportation priority does not align with a current mobility habit. For example, if a user has a transportation priority of getting to work within 10 minutes and the user's mobility habits indicate that the user's daily commute to work is 5 minutes, then the user's commuting need is met. However, if a user has a transportation priority of getting to work as inexpensively as possible, then a 10-minute commute with a personally owned car may not be the most cost-effective means of transportation, especially compared to a bicycle.

Referring now to FIG. 8, a flowchart of a process 800 for solution generation is depicted. The goal of the solution generation process 800 is to generate and recommend mobility solutions to the unmet needs identified by process 700. It should be understood that embodiments are not limited by the order of the steps shown in FIG. 8 nor are embodiments limited to the steps included in FIG. 8.

The solution generation process 800 begins at block 802 where unmet needs from a first profile sub-cluster of a first geographic region of a geospatial cluster are received. For example, a geospatial cluster may include cities such as Chicago and New York City, where Chicago and New York City are each a geographic region and contain profile sub-clusters. If a profile sub-cluster in downtown Chicago is surveyed to identify met and unmet needs, the system may receive the identified met and unmet needs at block 802 of process 800.

At block 804, a second region of the geospatial cluster of block 802 is identified. Continuing with the example in block 802, if Chicago is the first geographic region of a geospatial cluster, then New York City may be the second geographic region. Because, in this example, Chicago and New York City are in the same cluster, they are similar in terms of geospatial data and thus mobility solutions that work well in New York City are also likely to work well in Chicago.

At block 806, a second profile sub-cluster is identified based on the second geographic region. Continuing with the example in block 804, if Chicago is the first geographic region of the geospatial cluster, downtown Chicago may be the first profile sub-cluster, and New York City may be the second geographic region of the geospatial cluster, then Manhattan may be the second profile sub-cluster, assuming that the residents of downtown Chicago and Manhattan share similar profiling characteristics. As previously stated, because Chicago and New York City are in the same cluster, mobility solutions that work well in New York City are also likely to work well in Chicago. However, they may not be equally well received by residents of these areas. Accordingly, similar profile sub-clusters are identified to increase the likelihood that a mobility solution that was well received in one profile sub-cluster will also be well received in another.

At block 808, needs from the first and second profile sub-clusters may be compared to determine met needs from the second profile sub-cluster that are unmet in the first profile sub-cluster. In this sense, the second profile sub-cluster acts as a reference point for the first profile sub-cluster, which is seeking new mobility solutions. Continuing with the example in block 806, if a common need between downtown Chicago and Manhattan is affordable, on-demand transportation, the system may analyze the need to determine if it is met in Manhattan but not met in downtown Chicago. The system may then proceed to block 810.

At block 810, mobility solutions from the first and second profile sub-cluster may be compared to determine mobility solutions in the second profile sub-cluster that are not present in the first profile sub-cluster. Continuing with the example in block 808, downtown Chicago and Manhattan may have similar existing mobility solutions because they are the centers of their respective cities, but assume Manhattan has carpool ridesharing (e.g., UberPool or Lyft Line) whereas downtown Chicago does not. Because carpool ridesharing has likely met the need for affordable, on-demand transportation in Manhattan, carpool ridesharing may also meet the same need in downtown Chicago. In other words, since it has been determined that there is a need that is met in Manhattan but not met in downtown Chicago as well as a mobility solution that exists in Manhattan that does not exist in downtown Chicago, it is likely that the mobility solution that exists in Manhattan but not in downtown Chicago meets the need in Manhattan and is likely to also meet the same need in downtown Chicago if implemented. Therefore, carpool ridesharing may be recommended by the system to city planners, companies, and organizations seeking to implement new mobility solutions in the region.

However, if there are multiple unmet needs in downtown Chicago that are met in Manhattan as well as multiple mobility solutions in Manhattan that are not present in downtown Chicago, then more manual studies may be required. Nevertheless, the field of all potential mobility solutions, as well as potential case study locations, have been decreased significantly such that comprehensive case studies of locations throughout the country are no longer necessary to determine what is likely to be effective in downtown Chicago. City planners and companies looking to implement new mobility solutions in downtown Chicago only need to turn to the various mobility solutions of Manhattan as identified by the system to find potential success.

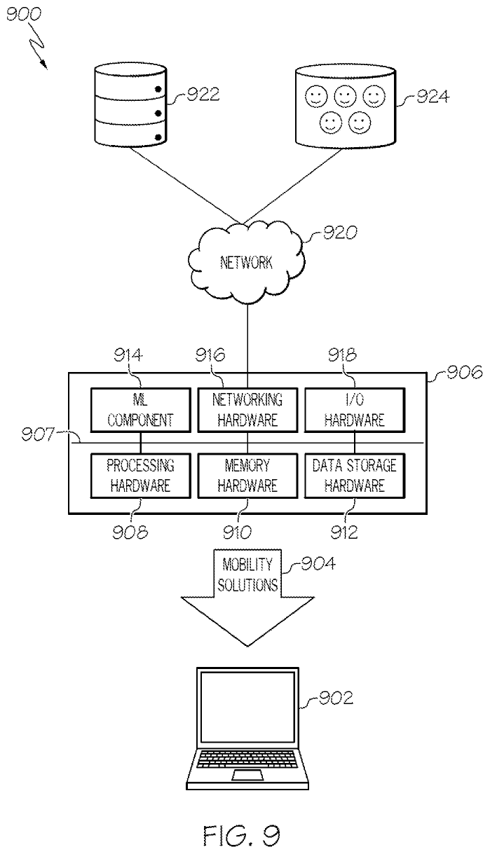

Referring now to FIG. 9, a schematic diagram of a computing system 900 for mobility solution recommendations using geospatial clustering is depicted. The system 900 may include a server device 906, a user computer 902, a network 920, geospatial data services 922, and profiling data services 924.

The server device 906 may be configured to perform the processes described herein. While in some embodiments, the server device 906 may be configured as a general-purpose computer with the requisite hardware, software, and/or firmware, in other embodiments, the server device 906 may be configured as a special purpose computer designed specifically for performing the functionality described herein. It should be understood that the software, hardware, and/or firmware components depicted may also be provided in other computing devices external to the server device 906 shown (e.g., data storage devices, remote server computing devices, and the like).

The server device 906 (and/or other additional computing devices) may include a processor 908, a communication path 907, a machine learning (ML) module 914, memory hardware 910, data storage hardware 912, input/output (I/O) hardware 918, network interface hardware 916 that may be connected to geospatial data services 922 and profiling data services 924 via network 920, or combinations thereof. It should be understood that the architecture of the system 900 as illustrated is only for demonstration purposes and is not intended to be limiting.

The processor 908 can be any device capable of executing machine-readable instructions. Accordingly, the processor 908 may be a controller, an integrated circuit, a microchip, a computer, or any other computing device. The processor 908 is communicatively coupled to the other components of the server device 906 by a communication path 907. Accordingly, the communication path 907 may communicatively couple any number of processors with one another, and allow the hardware coupled to the communication path 907 to operate in a distributed computing environment. Specifically, each of the hardware/component modules can operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like. The processor may include a machine learning module that may train and apply machine learning capabilities to a data set that may be stored in the data storage hardware 912. By way of example, and not as a limitation, a convolutional neural network (CNN) may be utilized.

The communication path 907 may be formed from any medium that is capable of transmitting a signal such as, for example, conductive wires, conductive traces, optical waveguides, and the like. In some embodiments, the communication path 907 may facilitate the transmission of wireless signals, such as Wi-Fi, Bluetooth, near field communication, and the like. Moreover, the communication path 907 may be formed from a combination of mediums capable of transmitting signals. In one embodiment, the communication path 907 comprises a combination of conductive traces, conductive wires, connectors, and buses that cooperate to permit the transmission of electrical data signals to components such as processors, memories, sensors, input devices, output devices, and communication devices. Additionally, it should be understood that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The machine learning module 914 may be incorporated into other hardware, such as the processor 908, or may exist as a distinct hardware component. The machine learning module 914 may include sub-components to train and otherwise assist in providing machine learning capabilities as described herein. By way of example and not of limitation, a convolutional neural network may be utilized. The machine learning module 914 may also leverage external computing services, such as cloud computing, to apply machine learning. Data stored and manipulated in the server device 906 as described herein is utilized by the machine learning module 914. This machine learning module 914 may create models that can be applied by the server device 906 to make it more efficient and intelligent in its execution of instructions.

The memory hardware 910 is communicatively coupled to the processor 908 via the communication path 907. The memory hardware 910 may be a non-transitory computer-readable medium and may be configured as non-volatile computer-readable memory. The memory hardware 910 may comprise RAM, ROM, flash memories, hard drives, or any device capable of storing machine-readable instructions such that the machine-readable instructions can be accessed and executed by the processor 908. The machine-readable instructions may comprise logic or algorithms written in any programming language, including low-level programming languages, such as machine code and assembly code, as well as high-level programming languages, such as object-oriented programming languages and scripting programming languages, that may be compiled or assembled into machine-readable instructions and stored on the memory hardware 910. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any computer programming language, as pre-programmed hardware elements, or as a combination of hardware and software components.

The I/O hardware 918 may include a display, keyboard, mouse, printer, camera, microphone, speaker, and/or other device for receiving, sending, and/or presenting data. In addition to or instead of using the network interface hardware 916, the I/O hardware 918 may receive the relevant datasets to implement the methods described herein, such as processes 100, 200, 500, 700, 800.

The data storage hardware 912 may store data used by various modules of the server device 906. It should be understood that the data storage hardware 912 may reside local to and/or remote from the server device 906, and may be configured to store one or more pieces of data for access by the server device 906 and/or other components. The data storage hardware 912 may contain data gathered from geospatial data services 922 and profiling data services 924 or as input via the I/O hardware 918. The data storage hardware 912 may also include index and/or cache data and results of previous operations, such as geographic maps and previously determined clusters thereof.

The network interface hardware 916 is coupled to the communication path 907 such that the communication path 907 communicatively couples the network interface hardware 916 to other modules of the server device 906. The network interface hardware 916 can be any device capable of transmitting and/or receiving data via a wireless network. The network interface hardware 916 can comprise a communication transceiver for sending and/or receiving data according to any wireless communication standard. Accordingly, the network interface hardware 916 can include a communication transceiver for sending and/or receiving any wired or wireless communication. For example, the network interface hardware 916 may include an antenna, modem, Ethernet port, Wi-Fi card, WiMax card, cellular modem, near-field communication hardware, satellite communication hardware, and/or any other wired or wireless hardware for communicating with other networks and/or devices. The network interface hardware 916 allows the server device 906 to interface with geospatial data services 922 and profiling data services 924.

The user computer 902 may have similar components to the server device 906. The user computer 902 may include a smartphone, a tablet, a laptop, and the like. The user computer 902 may be used by city planners and other users for obtaining recommended mobility solutions 904. The user computer 902 may have a user interface for a user to input a set of parameters, such as geographic locations. The user computer 902 may send a recommendation request to the server device 906 along with the parameters input by the user. The user computer 902 may receive the recommendation 904 and/or its corresponding data (e.g., maps 400 and 600) from the server device 906 for presentation to the user.

It should now be understood that embodiments of the present disclosure are directed to methods and systems that cluster regions of a geographic location to determine what types of mobility solutions are optimal for those regions and present them as recommendations to users. The users may include city planners or companies interested in developing a new mobility solution for a geographic region to tap into a mobility space that opens up a new market and new ways for its citizens or customers, as the case may be, to move around. When making the determination of what new mobility solution to develop, analyzing other geographic regions may provide critical insight. Cities having similar features may be a useful cue to provide similar mobility solutions. Furthermore, cities with individuals who have similar preferences or mobility habits while utilizing their city's mobility solutions may also be a useful clue as to how new mobility solutions may be received. The methods and systems disclosed herein enable a comprehensive analysis of mobility solutions throughout a geographic location in an automated fashion.

It should also be understood that relative terms, such as “substantially,” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for recommending mobility solutions, comprising:
receiving a set of geospatial data corresponding to a geographic location;
generating, by a machine learning module, a set of geospatial clusters based on the geographic location and the set of geospatial data, wherein each geospatial cluster of the set of geospatial clusters has a set of mobility solutions and a set of geographic regions;
receiving a set of profiling data corresponding to a set of users in each geospatial cluster;
generating, by the machine learning module, a set of profile sub-clusters corresponding to each geographic region based on the set of profiling data;
identifying a set of met needs and a set of unmet needs of the set of users in each profile sub-cluster; and
generating a mobility solution recommendation associated with a set of unmet needs of a set of users in a profile sub-cluster of a geospatial cluster.

2. The method of claim 1, wherein generating the mobility solution recommendation is based on a set of mobility solutions of a second profile sub-cluster of the geospatial cluster having a one or more met needs in a second set of met needs that corresponds to one or more unmet needs in the set of unmet needs.

3. The method of claim 1, further comprising before generating the set of geospatial clusters, preprocessing the set of geospatial data to remove noise and correct inconsistencies in the set of geospatial data.

4. The method of claim 1, further comprising before generating the set of profile sub-clusters, preprocessing the set of profiling data to remove noise and correct inconsistencies in the set of profiling data.

5. The method of claim 1, further comprising generating a cluster map having an image of a geographic location overlaid with the set of geospatial clusters to visualize the set of geospatial clusters.

6. The method of claim 5, wherein the cluster map is further overlaid with the set of profile sub-clusters.

7. The method of claim 1, wherein the set of geospatial data corresponding to the geographic location comprises data from one or more publicly available data sources.

8. The method of claim 1, wherein the set of profiling data includes a set of objective profiling data and a set of subjective profiling data.

9. The method of claim 8, wherein the set of objective profiling data includes at least one of a set of GPS data or a set of traffic data.

10. The method of claim 8, wherein the set of subjective profiling data includes at least one of a set of survey data or a set of personality data.

11. A system for recommending mobility solutions, comprising:
a processor;
a machine learning module;
a memory component communicatively connected to the processor; and
machine-readable instructions stored in the memory component that, when executed by the processor, cause the processor to:
receive a set of geospatial data corresponding to a geographic location;
generate, by the machine learning module, a set of geospatial clusters based on the geographic location and the set of geospatial data, wherein each geospatial cluster of the set of geospatial clusters has a set of mobility solutions and a set of geographic regions;
receive a set of profiling data corresponding to a set of users in each geospatial cluster;
generate, by the machine learning module, a set of profile sub-clusters corresponding to each geographic region based on the set of profiling data;
identify a set of met needs and a set of unmet needs of the set of users in each profile sub-cluster; and
generate a mobility solution recommendation associated with a set of unmet needs of a set of users in a profile sub-cluster of a geospatial cluster.

12. The system of claim 11, wherein generating the mobility solution recommendation is based on a set of mobility solutions of a second profile sub-cluster of the geospatial cluster having a one or more met needs in a second set of met needs that corresponds to one or more unmet needs in the set of unmet needs.

13. The system of claim 11, wherein the machine-readable instructions further cause the processor to, before generating the set of geospatial clusters, preprocess the set of geospatial data to remove noise and correct inconsistencies in the set of geospatial data.

14. The system of claim 11, wherein the machine-readable instructions further cause the processor to, before generating the set of profile sub-clusters, preprocess the set of profiling data to remove noise and correct inconsistencies in the set of profiling data.

15. The system of claim 11, wherein the machine-readable instructions further cause the processor to generate a cluster map having an image of a geographic location overlaid with the set of geospatial clusters to visualize the set of geospatial clusters.

16. The system of claim 15, wherein the cluster map is further overlaid with the set of profile sub-clusters.

17. The system of claim 11, wherein the set of geospatial data corresponding to the geographic location comprises data from one or more publicly available data sources.

18. The system of claim 11, wherein the set of profiling data includes a set of objective profiling data and a set of subjective profiling data.

19. The system of claim 18, wherein the set of objective profiling data includes at least one of a set of GPS data or a set of traffic data.

20. The system of claim 18, wherein the set of subjective profiling data includes at least one of a set of survey data or a set of personality data.
